(19) United States
(12) Patent Application Publication
(10) Pub. No.: US 2016/0088688 A1
(43) Pub. Date: Mar. 24, 2016

(54) MICROWAVE OVEN AND CONTROL METHOD THEREOF

(71) Applicant: Dongbu Daewoo Electronics Corporation, Seoul (KR)

(72) Inventor: Hyung Gu KANG, Ansan-si (KR)

(21) Appl. No.: 14/567,216

(22) Filed: Dec. 11, 2014

(30) Foreign Application Priority Data
Sep. 23, 2014 (KR) 10-2014-0126647

(51) Int. Cl. H05B 6/64; H05B 6/68; H05B 6/66

(52) U.S. Cl. CPC H05B 6/6444; H05B 6/662; H05B 6/687

(57) ABSTRACT

The present disclosure relates to a microwave oven and a control method thereof, and the method of controlling a microwave oven includes: accessing a cooking time; setting an operation time of a transformer as a first time for which the transformer is operated with a high output following a dormant time, a second time for which the transformer is operated with a low output until the end of the cooking time, a third time for which the transformer is operated at the low output following a time operating at the high output, and a fourth time for which the transformer is operated at high output following a time operating at the low output, according to a total cooking time including a previous cooking time and the input cooking time; and setting and controlling the output of the transformer in an order of the first time, the third time, the fourth time, and the second time.

### CROSS-REFERENCE TO RELATED APPLICATIONS

This application claims benefit and priority from Korean Patent Application No. 10-2014-0126647, filed on Sep. 23, 2014, with the Korean Intellectual Property Office, the disclosure of which is incorporated herein in its entirety by reference.

### TECHNICAL FIELD

The present disclosure relates to microwave oven, and more particularly, to an overheat control mechanism of microwave oven.

### BACKGROUND

In general, a microwave oven is an apparatus for heating and cooking food by using microwaves. As illustrated in FIG. 1, a microwave has a cooking chamber 5 disposed on the left side of the main body 1 which forms an exterior housing of the microwave oven. A key pad input unit 9 is installed at a right side of the main body 1 and used by users to select a cooking menu item, a cooking time, an output level, a start of cooking, and the like. The door 3 is hinged to the main body.

The microwave oven can automatically adjust its power output level. A conventional method of adjusting the power output involves controlling the on/off time ratio of power supplied to a high voltage transformer. For example, the output level may be decreased by shortening the “on” time (and accordingly extending the “off” time) within a predetermined period for a power relay connected between a power supply and the high voltage transformer. Likewise, the output level may be increased by increasing the “on” time for the power relay (and accordingly shortening the “off” time).

In the microwave oven in the conventional art, when a magnetron is continuously driven under the power supplied from a high voltage transformer for a long time, various electric components including the high voltage transformer may become overheated. Thus, the output level is usually adjusted with the cooking time during operation. For example, when the cooking time passes a predetermined time, the output level is decreased by controlling the power relay. Then the remaining cooking is performed at the decreased output level.

FIG. 2 is a diagram illustrating the process of adjusting an output level with the actual cooking time in the related art.

In FIG. 2, the numbers on the “TIME” axis represent time elapsed according to a progress of cooking in the units of a minute. The numbers on the “ACCUMULATED COOKING TIME” axis represent accumulated time in the progress of cooking in the units of a second. The accumulated time is tracked and calculated by a counter.

The cooking time accumulated in the counter is increased when the output level is equal to or greater than a predetermined reference output level (for example, 70%). The cooking time accumulated in the counter is decreased when the output level is smaller than the predetermined reference output level. For example, when a pause key is pressed by a user after five minutes from starting the microwave (T5), the power relay is turned off. That is, the microwave oven enters a cooling process and the value in the counter decreases from a counted value (300) at the time (T5) in the units of a second.

When the “pause” key is pressed again after 10 minutes from starting the microwave (T10), the power relay is on and cooking is performed, so that the value of the counter increases from a counted value (0) at T10 in the unit of a second.

When a “cancel” key is pressed at T20, the power relay is off and the microwave oven enters the cooling process. The value of the counter decreases from a counted value (600) at the time (T20) in the units of a second.

When a new cooking condition is set at T25, and thus the power relay is on, a new cooking process is performed according to the selected cooking condition. The value of the counter increases from the counted value (300) at T25 in the units of a second. When the increased counted value of the counter reaches a predetermined overheating preventing time (1,200 seconds), that is, when the counted value accumulated in the counter is 1,200 at T40, the “on” time within a predetermined period (for example, 30 seconds) for the power relay is shortened (shorter than 21 seconds) in order to prevent overheating. Thereby the time-average output level decreases to reference reduced output level (70%). Accordingly, the value of the counter decreases from the counted value (1,200) at T40 in the unit of second.

When the cooling time (at a reduced output level), e.g., 10 minutes, reaches a predetermined limit, the output level is restored to the initially set level by increasing the on time of the power relay (here T50). The value of the counter increases from the counted value (600) at T50 in the unit of a second. When the increased counted time reaches the predetermined overheating protection time (1,200 seconds) at T60, the “on” time within a predetermined period (for example, 30 seconds) for the power relay is accordingly shortened (shorter than 21 seconds) in order to prevent overheating. The output level is reduced to less than the original output level (70%). Accordingly, the value of the counter decreases from the counted value (1,200) at T60 in the unit of a second.

The operation of increasing and decreasing the cooking time by the counter according to a cooking state as described above is performed until the set cooking time ends. Then the counter resets the time value to an initial value.

However, in the conventional approach, when the microwave oven, or more specifically the transformer, operates at a performance of 100% for 20 minutes in a cooking process and it can only perform the next cooking process at a performance of 70%, regardless of the idle time between the two cooking processes. Thus, the performance of the microwave oven is not consistent.

### SUMMARY

Therefore it would be advantageous to provide a microwave oven and a control method thereof with consistent performance without overheating a transformer.

An exemplary embodiment of the present disclosure provides a method of controlling a microwave oven, including: accessing a cooking time; setting an operation time of a transformer as a first time for which the transformer is operated with a high output, a second time for which the transformer is operated with a low output, a third time for which the transformer is operated from the high output to the low output, and a fourth time for which the transformer is operated from the low output to the high output, according to a sum of a previous cooking time and the current user-requested cooking time; and setting and controlling the output of the transformer in an order of the first time, the third time, the fourth time, and the second time.

Another exemplary embodiment of the present disclosure provides a microwave oven, including: a storage unit configured to store a previous cooking time; an input unit configured to receive a cooking time; a magnetron configured to generate a high frequency; a transformer configured to supply a driving voltage to the magnetron; and a controller configured to set a first time for which the transformer is operated with a high output following a cool-off time, a second time for which the transformer is operated with a low output, a third time for which the transformer operates at the low output following operating at the high output, and a fourth time for which the transformer operates at the high output following the low output, in consideration of the previous cooking time stored in the storage unit and the cooking time input by the input unit. The transformer is controlled to perform in an order of the first time, the third time, the fourth time, and the second time.

According to the exemplary embodiments of the present disclosure, a microwave can determine a time for which the transformer operates at its maximum performance, set the calculated time according to a total cooking time, and control the transformer accordingly. Thereby the efficiency of the transformer can be optimized without overheating while making previous cooking have less impact and influence to the next cooking such that consistent cooking performance can be achieved.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 is a perspective view illustrating a general microwave oven;

FIG. 2 is a diagram describing an operation of adjusting an output level according to a counted cooking time by counting the cooking time in the related art;

FIG. 3 is a diagram describing an operation of an exemplary microwave oven according to an embodiment of the present disclosure.

FIG. 4 is a block diagram illustrating a configuration inside the exemplary microwave oven according to an embodiment of the present disclosure;

FIG. 5 is a flowchart illustrating an exemplary method of controlling the microwave oven according to an embodiment of the present disclosure.

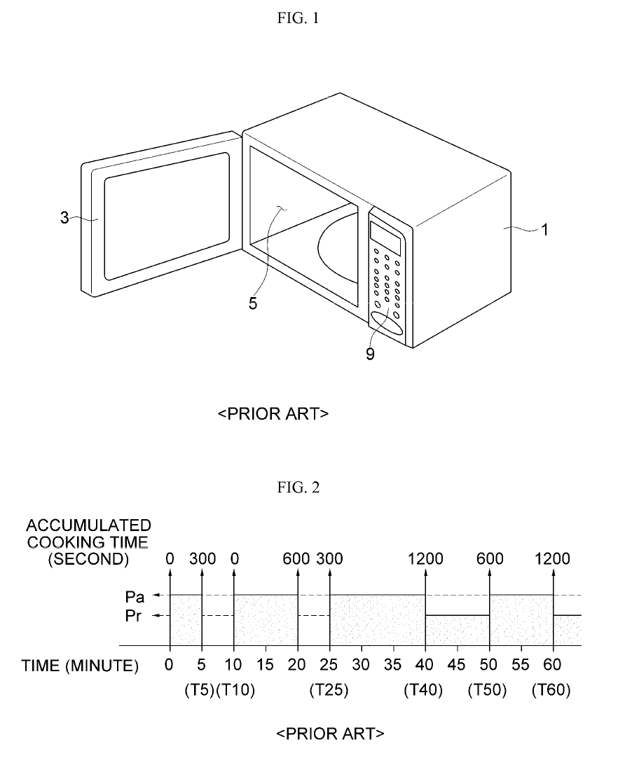

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or client devices. When a component appears in several embodiments, the use of the same reference numeral signifies that the component is the same component as illustrated in the original embodiment.

### Microwave Oven and Control Method Thereof

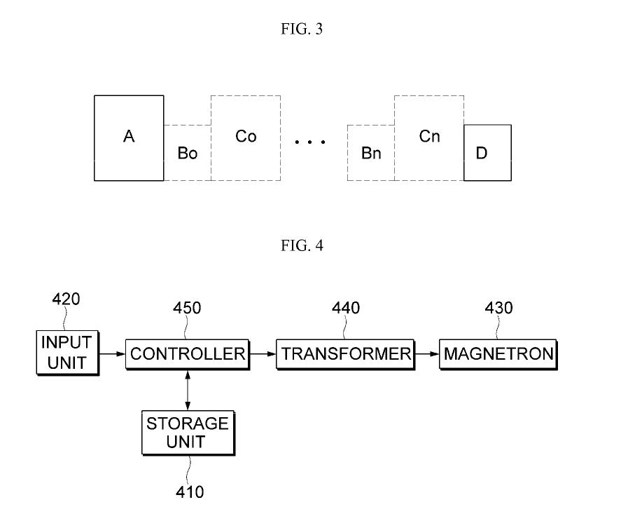

FIG. 3 is a diagram illustrating an exemplary method of operating a microwave oven according to an embodiment of the present disclosure.

Based on the specification of the transformer, a first time A is set and corresponds to the time segment for the transformer to perform at a maximum performance (100%) from a dormant state; the third time B is set and corresponds to a time segment for the transformer to perform at a reduced performance (e.g., 70%); the fourth time C is set and corresponds to a time segment for the transformer to return to 100% performance; and the second time D is set and corresponds to a time segment for the transformer to operate at the reduced performance 70% again until the preset cooking time ends.

For instance, the first time segment A may be set as 0 to 30 minutes. The third time segment B may be set as 0 to 5 minutes, which is about 20% of the first time segment A. The fourth time segment C may be set as 0 to 15 minutes, which is about 50% of the first time segment A. The second time segment B may be set as 0 to 5 minutes, which is about 20% of the first time segment A.

Referring to FIG. 3, the microwave oven according to the exemplary embodiment of the present disclosure sets the durations for the first time segment A, the third time segment B, the fourth time segment C, and the second time segment D based on the “total cooking time” which is defined as a sum of the actual cooking time of a previous cooking process (or the previous cooking time) and a current input cooking time. More particularly, the microwave oven according to embodiments of the present disclosure programs a sequence of time segments where the transformer operates at either 100% or 70% of its output level. The transformer switches from 100% to 70% of the output level before reaching an overheating time limit. The output level of the transformer automatically switches back to 100% after operating at the reduced level for a predetermined cooling time until the cooking ends. That is, the microwave oven according to the present disclosure alternately operates at the full (100%) and the reduced (70%) power output levels. That is, the third time segment B and the fourth time segment C are repeated until the end of the total time. In order to achieve uniform cooking performance and improve efficiency in an immediately subsequent cooking process, the transformer preferably operates at the reduced performance level (70%) in the last cooking segment (D), at which the cooking is completed, except for a specific case.

According to embodiments of the present disclosure, as the transformer temperature will not rise to a detrimental level when it operates at a reduced performance level (e.g., 70%), the cooking time is advantageously unrestricted by the transformer heating issues.

If the currently cooking process is cancelled, the microwave oven according to the present disclosure accumulates the actual cooking time, and resets the first time segment A, the third time segment B, the fourth time segment C, and the second time segment D for a subsequently input cooking time.

FIG. 4 is a block diagram illustrating the configuration of an exemplary microwave oven according to an embodiment of the present disclosure.

Referring to FIG. 4, the microwave oven includes a storage unit 410, an input unit 420, a magnetron 430, a transformer 440, a controller 450, and the like.

The storage unit 410 stores a previous cooking time.

The input unit 420 includes a plurality of keys or buttons to receive user instructions with respect to cooking menu item, cooking time and power output level, start, pause, and end of cooking, and the like.

The magnetron 430 generates high frequency microwaves for heating food.

The transformer 440 supplies a driving voltage to the magnetron 430.

The controller 450 sequentially sets the first time segment A for the transformer 440 to operate at the 100% performance following a dormant state, a second time segment D for the transformer 440 to operate at 70% performance level until the cooking process ends, a third time segment B for the transformer 440 to operate at the 70% performance level following a time at the 100% performance level, and a fourth time C for the transformer 440 to operate at 100% following a time at the 70% performance level. According to the total cooking time which is equal to a previous cooking time stored in the storage unit 410 plus a cooking time input received through the input unit 420, the transformer 440 operates in the order of the first time A, the third time B, the fourth time, C, and the second time D.

More particularly, if a total cooking time is equal to or greater than the predetermined first time value, the controller 450 sets the predetermined first time value as the first time A. If a first residual cooking time obtained by subtracting the first time A from the total cooking time is equal to or greater than a predetermined third time value, the controller 450 sets the predetermined third time value as the second time D. If a second residual cooking time obtained by subtracting the second time D from the first residual cooking time is equal to or greater than a predetermined fourth time value, the controller 450 sets the predetermined fourth time value as the third time B. If a third residual cooking time obtained by subtracting the third time B from the second residual cooking time is equal to or greater than a predetermined second time value, the controller 450 sets the predetermined second time value as the fourth time C. Here, if a fourth residual cooking time obtained by subtracting the fourth time C from the third residual cooking time is greater than 0, the controller 450 sets additional third time B segment(s) and/or fourth time C segment(s) in the sequence.

If the total cooking time is smaller than the predetermined first time value, the controller 450 sets the input cooking time as the first time A. If the first residual cooking time is smaller than the predetermined third time value, the controller 450 sets the first residual cooking time as the second time D. If the second residual cooking time is smaller than the predetermined fourth time value, the controller 450 sets the second residual cooking time as the third time B.

If the third residual cooking time is smaller than the predetermined second time value, the controller 450 sets the third residual cooking time as the fourth time C.

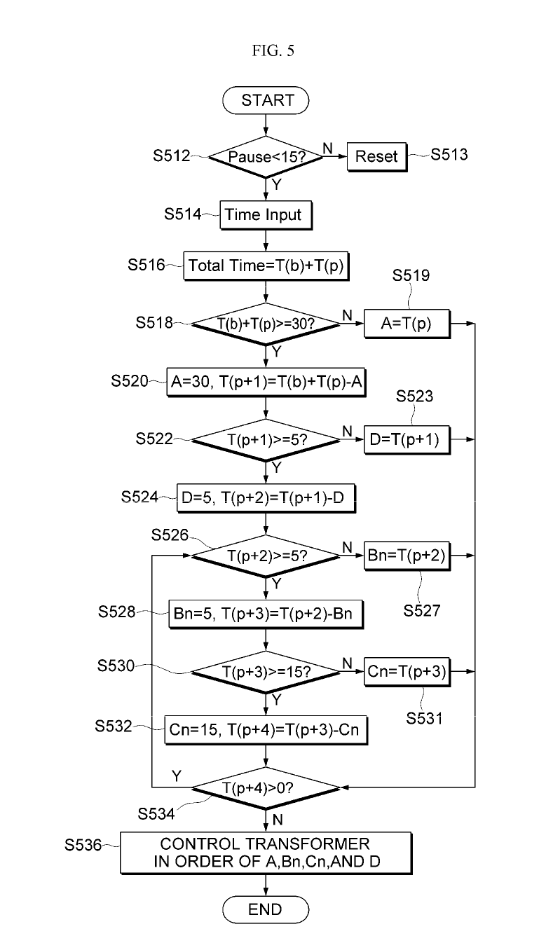

FIG. 5 is a flowchart illustrating an exemplary method of controlling the microwave oven according to an embodiment of the present disclosure.

Referring to FIG. 5, it is determined whether a dormant time of the transformer 440 is smaller than a predetermined reference value (for example, 15 minutes) (S512). If the dormant time of the transformer 440 is equal to or greater than the predetermined reference value, a previous cooking time (T(b)) is initialized (S513).

If the dormant time of the transformer 440 is smaller than the predetermined reference value, a cooking time (T(p)) is received from a user (S514).

A total cooking time is calculated by summing the previous cooking time (T(b)) and the current input cooking time (T(p)) (S516).

It is determined whether the total cooking time is equal to or greater than a predetermined first time value (for example, 30 minutes) (S518), and if the total cooking time is smaller than the predetermined first time value, the input cooking time (T(p)) is set as a first time A (S519).

If the total cooking time is equal to or greater than the predetermined first time value, the predetermined first time value is set as the first time A, and a first residual cooking time (T(p+1)) is calculated by subtracting the first time A form the total cooking time (S520).

It is determined whether the first residual cooking time (T(p+1)) is equal to or greater than a predetermined third time value (for example, 5 minutes) (S522), and if the first residual cooking time (T(p+1)) is smaller than the predetermined third time value, the first residual cooking time (T(p+1)) is set as the second time D (S523).

If the first residual cooking time (T(p+1)) is equal to or greater than the predetermined third time value, the predetermined third time value is set as the second time D, and a second residual cooking time (T(p+2)) is calculated by subtracting the second time D from the first residual cooking time (T(p+1)) (S524).

Next, it is determined whether the second residual cooking time (T(p+2)) is equal to or greater than a predetermined fourth time value (for example, 5 minutes) (S526), and if the second residual cooking time (T(p+2)) is smaller than the predetermined fourth time value, the second residual cooking time (T(p+2)) is as the third time B (S527).

If the second residual cooking time (T(p+2)) is equal to or greater than the predetermined fourth time value, the predetermined fourth time value is set as the third time B, and a third residual cooking time (T(p+3)) is calculated by subtracting the third time B from the second residual cooking time (T(p+2)) (S528).

It is determined whether the third residual cooking time (T(p+3)) is equal to or greater than a predetermined second time value (for example, 15 minutes) (S530), and if the third residual cooking time (T(p+3)) is smaller than the predetermined second time value, the third residual cooking time (T(p+3)) is as the fourth time C (S531).

If the third residual cooking time (T(p+3)) is equal to or greater than the predetermined second time value, the predetermined second time value is set as the fourth time C, and a fourth residual cooking time (T(p+4)) is calculated by subtracting the fourth time C from the third residual cooking time (T(p+3)) (S532).

It is determined whether the fourth residual cooking time (T(p+4)) exceeds 0 (S534), and if the fourth residual cooking time (T(p+4)) exceeds 0, the process returns to operation S526 and the third time B and the fourth time C are repeated n times (here, n is a natural number).

Last, when the fourth residual cooking time (T(p+4)) is 0, the transformer 440 is controlled in an order of the first time A, a third time Bn, a fourth time Cn, and the second time D (S536).

The aforementioned method may be implemented by various techniques. For example, the exemplary embodiments of the present disclosure can be implemented by hardware, firmware, software, or a combination thereof.

When the exemplary embodiments of the present disclosure are implemented by hardware, a method according to the exemplary embodiments of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, and microprocessors.

When the exemplary embodiments of the present disclosure are implemented by firmware or software, a method according to the exemplary embodiments of the present disclosure may be implemented in the form of a module, a procedure, a function, and the like performing the aforementioned functions or operations. A software code may be stored in a memory unit and driven by a processor. The memory unit may be inside or outside the processor to transceive data with the processor in any suitable means that is well known in the art.

The exemplary embodiments disclosed in the present specification have been described with reference to the accompanying drawings. As described above, the exemplary embodiments illustrated in the respective drawings shall not be limitedly construed, and it may be construed that the exemplary embodiments may be combined by those fully understanding the contents of the present specification, and when the exemplary embodiments are combined, some constituent elements may be omitted.

Here, the terms or words used in the present specification and the claims should not be construed as being limited as a commonly used or lexical meaning, and should be construed as a meaning and a concept to conform with the technical spirit disclosed in the present specification.

Therefore, the exemplary embodiments described in the present specification and the configurations illustrated in the drawings are only an exemplary embodiment disclosed in the present disclosure and do not represent all of the technical spirit of the present disclosure, and thus it is to be understood that various equivalent matters and modified examples, which may replace the configurations, are possible at the time of filing the present application.

The exemplary embodiments of the present disclosure have been described, but terms and expressions used in the description of the exemplary embodiments are only used for illustrating the exemplary embodiments, and shall not be used to limit contents or the scope of the terms and the expression described in the claims of the present specification.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method of controlling a microwave oven having a transformer, the method comprising:
accessing a user input cooking time;
determining a first time corresponding to a time segment for the transformer to operate at a high output;
determining a second time corresponding to a time segment for the transformer to operate at a low output;
determining a third time corresponding to a time segment for the transformer to operate at the low output following operating at the high output;
determining a fourth time corresponding to a time segment for the transformer to operate at the high output following operating at the low output, wherein the determinings are based on a total cooking time comprising a previous actual cooking time and a current input cooking time; and
controlling the transformer to operate in an order of the first time, the third time, the fourth time, and the second time.

2. The method of claim 1, further comprising:
determining a dormant time of the transformer prior to receiving the user input cooking time;
comparing the dormant time with a predetermined reference value; and
initializing the previous actual cooking time if the dormant time of the transformer is equal to or greater than the predetermined reference value.

3. The method of claim 1, wherein the determinings comprise:
determining whether the total cooking time is equal to or greater than a predetermined first time value;
if the total cooking time is equal to or greater than the predetermined first time value, setting the predetermined first time value as the first time;
determining whether a first residual cooking time indicating a value obtained by subtracting the first time from the total cooking time is equal to or greater than a predetermined third time value;
if the first residual cooking time is equal to or greater than the predetermined third time value, setting the predetermined third time value as the second time;
determining whether a second residual cooking time indicating a value obtained by subtracting the second time from the first residual cooking time is equal to or greater than a predetermined fourth time value;
if the second residual cooking time is equal to or greater than the predetermined fourth time value, setting the predetermined fourth time value as the third time;
determining whether a third residual cooking time indicating a value obtained by subtracting the third time from the second residual cooking time is equal to or greater than a predetermined second time value; and
if the third residual cooking time is equal to or greater than the predetermined second time value, setting the predetermined second time value as the fourth time.

4. The method of claim 3, wherein the setting of the operation time of the transformer includes determining whether a fourth residual cooking time indicating a value obtained by subtracting the fourth time from the third residual cooking time exceeds 0, and
if the fourth residual cooking time exceeds 0, the process returns to the operation of determining whether the second residual cooking time is equal to or greater than the predetermined fourth time value.

5. The method of claim 3, further comprising:
if the total cooking time is smaller than a predetermined first time value, setting the input cooking time as the first time.

6. The method of claim 3, further comprising:
if the first residual cooking time is smaller than the predetermined third time value, setting the first residual cooking time as the second time.

7. The method of claim 3, further comprising:
if the second residual cooking time is smaller than the predetermined fourth time value, setting the second residual cooking time as the third time.

8. The method of claim 3 further comprising:
if the third residual cooking time is smaller than the predetermined second time value, setting the third residual cooking time as the fourth time.

9. The method of claim 3, wherein the third time has a smaller value than that of the first time, and wherein the first time and the second time have smaller values than that of the third time.

10. A microwave oven, comprising:
a storage unit configured to store a previous cooking time;
an input unit configured to receive a cooking time;
a magnetron configured to generate a high frequency;
a transformer configured to supply a driving voltage to the magnetron; and
a controller configured to set a first time for which the transformer is operated with a high output, a second time for which the transformer is operated with a low output, a third time for which the transformer is operated from the high output to the low output, and a fourth time for which the transformer is operated from the low output to the high output, in consideration of the previous cooking time stored in the storage unit and the cooking time input by the input unit, and then control the transformer in an order of the first time, the third time, the fourth time, and the second time.

11. The microwave oven of claim 10, wherein if a total cooking time including the previous cooking time and the input cooking time is equal to or greater than a predetermined first time value, the controller sets the predetermined first time value as the first time, if a first residual cooking time indicating a value obtained by subtracting the first time from the total cooking time is equal to or greater than a predetermined third time value, the controller sets the predetermined third time value as the second time, if a second residual cooking time indicating a value obtained by subtracting the second time from the first residual cooking time is equal to or greater than a predetermined fourth time value, the controller sets the predetermined fourth time value as the third time, and if a third residual cooking time indicating a value obtained by subtracting the third time from the second residual cooking time is equal to or greater than a predetermined second time value, the controller sets the predetermined second time value as the fourth time, and if a fourth residual cooking time indicating a value obtained by subtracting the fourth time from the third residual cooking time exceeds 0, the controller sets the third time and the fourth time to be repeated.

12. The microwave oven of claim 11, wherein if the total cooking time is smaller than the predetermined first time value, the controller sets the input cooking time as the first time.

13. The microwave oven of claim 11, wherein if the first residual cooking time is smaller than the predetermined third time value, the controller sets the first residual cooking time as the second time.

14. The microwave oven of claim 11, wherein if the second residual cooking time is smaller than the predetermined fourth time value, the controller sets the second residual cooking time as the third time.

15. The microwave oven of claim 11, wherein if the third residual cooking time is smaller than the predetermined second time value, the controller sets the third residual cooking time as the fourth time.
